(19) United States
(12) Patent Application Publication
(10) Pub. No.: US 2024/0172252 A1
(43) Pub. Date: May 23, 2024

(54) TERMINAL AND COMMUNICATION METHOD

(71) Applicant: NTT DOCOMO, INC., Tokyo (JP)

(72) Inventors: Takuma Nakamura, Chiyoda-ku, Tokyo (JP); Tomoya Ohara, Chiyoda-ku, Tokyo (JP); Shinya Kumagai, Chiyoda-ku, Tokyo (JP); Daisuke Kurita, Chiyoda-ku, Tokyo (JP)

(73) Assignee: NTT DOCOMO, INC., Tokyo (JP)

(21) Appl. No.: 18/551,313

(22) PCT Filed: Mar. 31, 2021
(86) PCT No.: PCT/JP2021/014074

§ 371 Date: Sep. 19, 2023

(51) Int. Cl. H04W 72/25; H04W 24/10; H04W 68/02; H04W 88/04

(52) U.S. Cl. CPC H04W 72/25; H04W 24/10; H04W 68/02; H04W 88/04

(57) ABSTRACT

A terminal includes a communication unit configured to perform transmission of a signal to and reception of a signal from a base station; and a control unit configured to transmit, to another terminal, information that is received from the base station based on the transmission and the reception, or information that is obtained from the signal transmitted to or received from the base station.

### TECHNICAL FIELD

The present invention relates to a terminal and a communication method in a wireless communication system.

### BACKGROUND ART

With regard to NR (New Radio) (also referred to as “5G”), which is a successor system of LTE (Long Term Evolution), a technology has been being studied that satisfies requirements such as a large-capacity system, a high-speed data transmission rate, a low delay, simultaneous connection of a large number of terminals, low cost, and power saving (for example, see Non-Patent Document 1).

Further, study of 6G has been started as a next-generation wireless communication system of 5G, and realization of wireless qualities exceeding 5G is expected. For example, with regard to 6G, studies are underway toward realization of higher capacities, use of new frequency bands, lower delay, higher reliability, extension of coverage in new regions (high altitude, sea, space), and the like (for example, see Non-Patent Document 2).

### PRIOR ART DOCUMENT

### Non Patent Document

[Non-Patent Document 1] 3GPP TS 38.300 V16. 4.0 (2020-12)

[Non-Patent Document 2] White Paper, 5G Evolution and 6G, NTT DOCOMO, INC. (2020-01)

### SUMMARY OF THE INVENTION

### Problem to be Solved by the Invention

Each terminal that has transitioned to an NR idle mode or an inactive mode needs to execute many operations such as SSB (SS/PBCH block) reception for synchronization establishment, paging reception, and RRM (Radio resource management) measurement, and therefore, it is difficult to reduce power consumption.

The present invention has been made in view of the above points, and can reduce power consumption of a terminal in an idle mode or an inactive mode in a wireless communication system.

### Means for Solving the Problem

According to a disclosed technology, there is provided a terminal including a communication unit configured to perform transmission of a signal to and reception of a signal from a base station; and a control unit configured to transmit, to another terminal, information that is received from the base station based on the transmission and the reception, or information that is obtained from the signal transmitted to or received from the base station.

### Advantageous Effects of the Invention

According to the disclosed technology, it is possible to reduce power consumption of a terminal in an idle mode or an inactive mode in a wireless communication system.

### BRIEF DESCRIPTION OF THE DRAWINGS

FIG. 1 is a diagram showing a configuration example of a wireless communication system according to an embodiment of the present invention.

FIG. 2 is a diagram showing an operation example related to paging in LTE.

FIG. 3 is a diagram showing an operation example related to paging in NR.

FIG. 4 is a diagram showing an operation example in an idle mode or an inactive mode.

FIG. 5 is a diagram showing an operation example in an idle mode or an inactive mode according to the embodiment of the present invention.

FIG. 6 is a flowchart showing an example of information notification according to the embodiment of the present invention.

FIG. 7 is a diagram showing an operation example (1) of a leader UE according to the embodiment of the present invention.

FIG. 8 is a diagram showing an operation example (2) of a leader UE according to the embodiment of the present invention.

FIG. 9 is a diagram showing an operation example (3) of a leader UE according to the embodiment of the present invention.

FIG. 10 is a diagram showing an example of a timeline of data sharing according to the embodiment of the present invention.

FIG. 11 is a diagram showing an example (1) of resources used for data sharing according to the embodiment of the present invention.

FIG. 12 is a diagram showing an example (2) of resources used for data sharing according to the embodiment of the present invention.

FIG. 13 is a diagram showing an example (1) of grouping according to the embodiment of the present invention.

FIG. 14 is a diagram showing an example (2) of grouping according to the embodiment of the present invention.

FIG. 15 is a sequence diagram showing an example (1) of group entering according to the embodiment of the present invention.

FIG. 16 is a sequence diagram showing an example (2) of group entering according to the embodiment of the present invention.

FIG. 17 is a diagram showing an example (3) of grouping according to the embodiment of the present invention.

FIG. 18 is a diagram showing an operation example (1) of another UE according to the embodiment of the present invention.

FIG. 19 is a diagram showing an operation example (2) of another UE according to the embodiment of the present invention.

FIG. 20 is a diagram showing an example of a functional configuration of a base station 10 according to the embodiment of the present invention.

FIG. 21 is a diagram showing an example of a functional configuration of a terminal 20 according to the embodiment of the present invention.

FIG. 22 is a diagram showing an example of a hardware configuration of the base station 10 or the terminal 20 according to the embodiment of the present invention.

### MODE FOR CARRYING OUT THE INVENTION

Hereinafter, the embodiment of the present invention will be described with reference to the drawings. It should be noted that the embodiment described below is merely an example, and embodiments to which the present invention is applied are not limited to the following embodiment.

In operations of a wireless communication system according to the embodiment of the present invention, an existing technique is appropriately used. However, the existing technology is, for example, the existing LTE, but is not limited to the existing LTE. In addition, the term “LTE” used in the present specification has a broad meaning and means the LTE-Advanced and schemes after the LTE-Advanced (example, NR) unless otherwise specified.

In addition, in the embodiment of the present invention described below, terms used in legacy LTE such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), and the like are used. This is for convenience of description, and signals, functions, and the like similar to these may be referred to by other names. Also, the above terms in NR correspond to NR-SS, NR-PSS, NR-SSS, NR-PBCH, NR-PRACH, etc. However, even a signal used for NR is not necessarily specified as “NR-”.

Further, in the embodiment of the present invention, the duplex scheme may be a TDD (Time Division Duplex) scheme, an FDD (Frequency Division Duplex) scheme, or another scheme (for example, Flexible Duplex).

In addition, in the embodiment of the present invention, a radio parameter or the like being “configured” may be a predetermined value being pre-configured or a radio parameter notified from a base station 10 or a terminal 20 being configured.

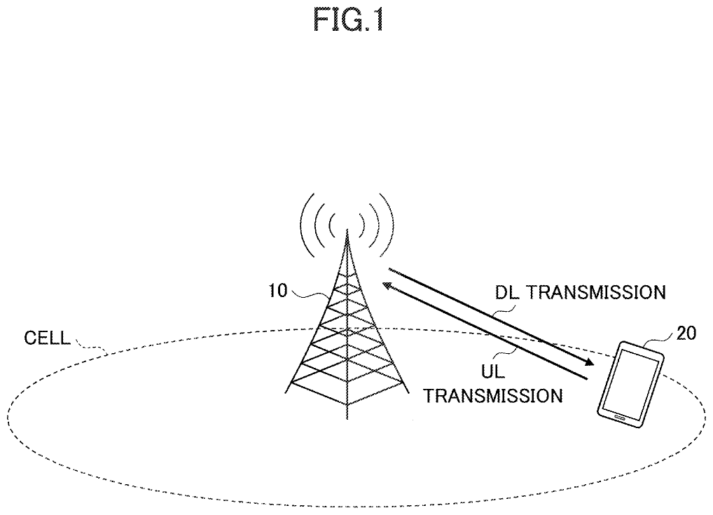

FIG. 1 is a diagram illustrating a configuration example of a wireless communication system according to the embodiment of the present invention. As shown in FIG. 1, the wireless communication system according to the embodiment of the present invention includes a base station 10 and a terminal 20. Although one base station 10 and one terminal 20 are shown in FIG. 1, this is merely an example, and a plurality of base stations 10 and a plurality of terminals 20 may be included.

The base station 10 is a communication apparatus that provides one or more cells and performs wireless communication with the terminal 20. A physical resource of a radio signal is defined in a time domain and a frequency domain, and the time domain may be defined by the number of orthogonal frequency division multiplexing (OFDM) symbols. The frequency domain may be defined by the number of subcarriers or the number of resource blocks. The base station 10 transmits a synchronization signal and system information to the terminal 20. The synchronization signal is, for example, an NR-PSS or an NR-SSS. The system information is transmitted through a NR-PBCH, for example, and is also referred to as broadcast information. The synchronization signal and the system information may be referred to as SSB (SS/PBCH block). As shown in FIG. 1, the base station 10 transmits a control signal or data to the terminal 20 through a downlink (DL), and receives a control signal or data from the terminal 20 through an uplink (UL). Both the base station 10 and the terminal 20 are capable of transmitting and receiving signals by performing beamforming. In addition, both the base station 10 and the terminal 20 can apply communication using MIMO (Multiple Input Multiple Output) to DL or UL. Also, each of both the base station 10 and the terminal 20 may perform communication via a secondary cell (SCell) and a primary cell (PCell) according to carrier aggregation (CA). Furthermore, the terminal 20 may perform communication via the primary cell of the base station 10 or via a primary secondary cell group cell (PSCell: Primary SCG Cell) of another base station 10 according to DC (Dual Connectivity).

The terminal 20 is a communication apparatus having a wireless communication function such as a smartphone, a mobile phone, a tablet, a wearable terminal, or a M2M (Machine-to-Machine) communication module. The terminal 20 uses various communication services provided by the wireless communication system by receiving a control signal or data from the base station 10 through a DL and transmitting a control signal or data to the base station 10 through an UL, as illustrated in FIG. 1. In addition, the terminal 20 receives various reference signals transmitted from the base station 10, and measures the channel quality based on the reception result of the reference signals.

The power consumption of a NR terminal in an idle mode or an inactive mode is increased compared to that of a LTE terminal. A sleep operation of a terminal 20 in an idle mode or an inactive mode is classified into deep sleep, light sleep, microsleep, and the like in ascending order of power consumption according to the sleep time.

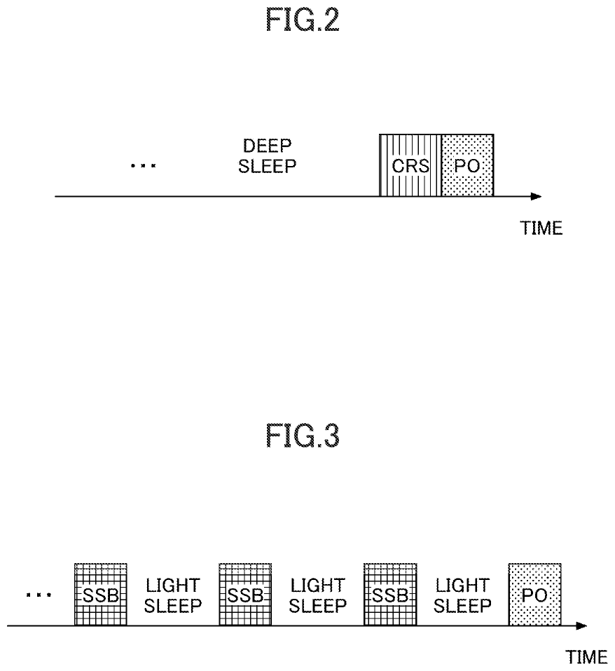

FIG. 2 is a diagram illustrating an operation example related to paging in LTE. FIG. 3 is a diagram illustrating an operation example related to paging in NR. As shown in FIG. 2, in LTE, a transition is made to a deep sleep state, and after that, wake-up is performed to receive a cell specific reference signal (CRS) and receive a paging occasion (PO). As shown in FIG. 3, in NR, an operation of receiving a paging occasion is performed after receiving an SSB and establishing synchronization. A terminal in an idle mode or an inactive mode transitions to a light sleep state, then wakes up to receive a SSB (SS/PBCH block), and thus performs tracking with respect to time domain and frequency domain.

Therefore, in NR, in order to receive a paging occasion, it is necessary to wake up earlier than a case of LTE before the paging occasion, and it is necessary to repeat waking up frequently.

As described above, each terminal having transitioned to an NR idle mode or an inactive mode needs to execute many operations such as SSB reception for synchronization establishment, paging reception, and radio resource management (RRM) measurement. Therefore, it is difficult for the terminal to reduce power consumption.

Therefore, grouping is performed by a plurality of UEs existing in the same cell, and the UEs in the group cooperate with each other, thereby improving the efficiency of operations of the terminals 20 each in an idle mode or an inactive mode and reducing the power consumption thereof.

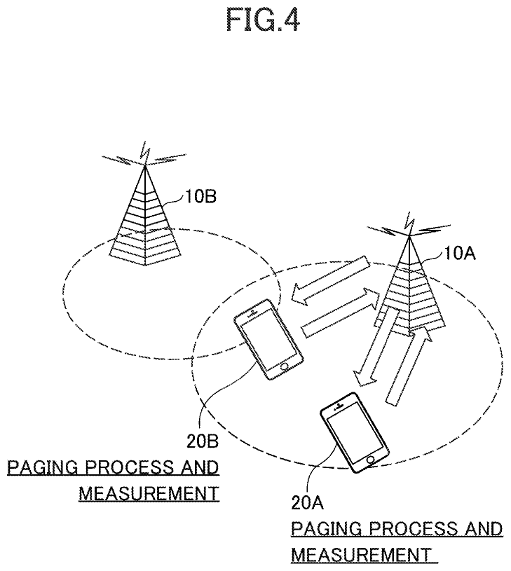

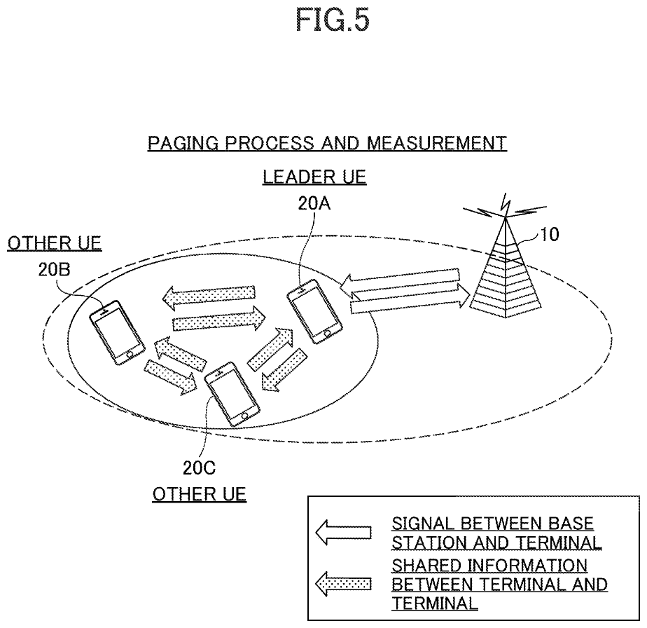

FIG. 4 is a diagram illustrating an operation example in an idle mode or an inactive mode. As shown in FIG. 4, conventionally, all the terminals 20 separately perform necessary operations, that is, a paging process, measurement, and the like.

FIG. 5 is a diagram illustrating an operation example in an idle mode or an inactive mode according to the embodiment of the present invention. As shown in FIG. 5, a terminal 20A, which is a leader UE, representatively performs an operation of a UE that is in an idle mode to communicate with a base station 10, and performs a paging process, measurement, and the like. In FIG. 5, the group includes terminals 20A, 20B, and 20C. The terminal 20A which is the leader UE and the terminal 20B and the terminal 20C which belong to the group share, in the group, the operation result obtained by the leader UE. The terminals 20B and 20C other than the leader UE thus can simplify their operations and reduce the power consumption accordingly.

The leader UE may be a terminal 20 that performs a necessary terminal operation in an idle mode or an inactive mode and shares an operation result in the group. The leader UE may be a terminal 20 that communicates with the base station 10 when performing inter-group communication with the base station 10. The leader UE may notify the other terminals 20 in the group of all or part of the obtained information. A single leader UE may be configured per group, or a plurality of leader UEs may be configured per group.

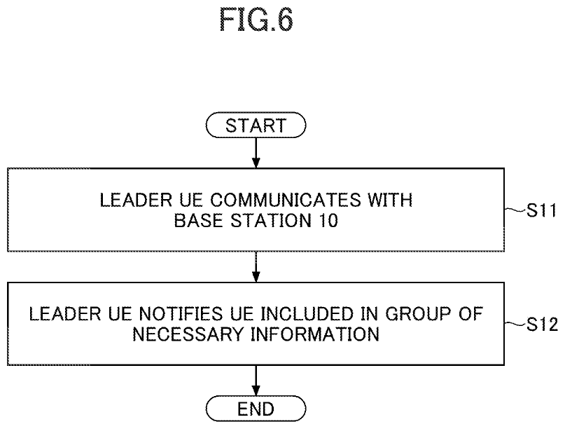

FIG. 6 is a flowchart showing an example of information notification according to the embodiment of the present invention. In step S11, a leader UE communicates with a base station 10. The communication may be of a paging process or may be of measurement or the like. In the following step S12, the leader UE informs another UE in a group of necessary information. Hereinafter, a UE other than a leader UE in a group will be referred to as “another UE” or “the other UE”.

In step S12, the information notified from the leader UE to the other UE may be at least one of the following items of information 1) to 5):
1) whether there is a change of the leader UE or a change in the state (between an idle mode or an inactive mode and a connected mode) of the leader UE
2) group switching instruction to the other UE
3) instruction to the other UE to transition to a connected mode
4) a result of an operation performed by the leader UE as a representative
5) information (ETWS (Earthquake and Tsunami Warning System), paging message, the like) to be notified from the base station 10 to the other UE

In addition, the leader UE may receive, from another leader UE when there are a plurality of leader UEs or from the other UE, a result of an operation executed by the other leader UE as a representative, or may receive, from the other UE, information to be notified to the leader UE and to the base station 10, for example, an identifier of the other UE, a group identifier, or the like.

A leader UE and a function thereof in a group may be determined or switched according to a network instruction or an implementation of the leader UE. The determination or switching of the leader UE may be performed based on at least one of 1) to 5) described below. When a leader UE is switched, information indicating a terminal 20 that has newly become a leader UE may be reported to the base station 10.
1) switching according to a timer
2) the battery state of the leader UE
3) switching based on reception strength or quality measured by the UE (for example, RSRP (Reference Signal Received Power), SINR (Signal to Interference plus Noise Ratio), RSSI (Received Signal Strength Indicator), RSRQ (Reference Signal Received Quality)) or the like
4) notification from the base station 10 (for example, DCI, MAC-CE, RRC, SIB, or the like)
5) the UE capability

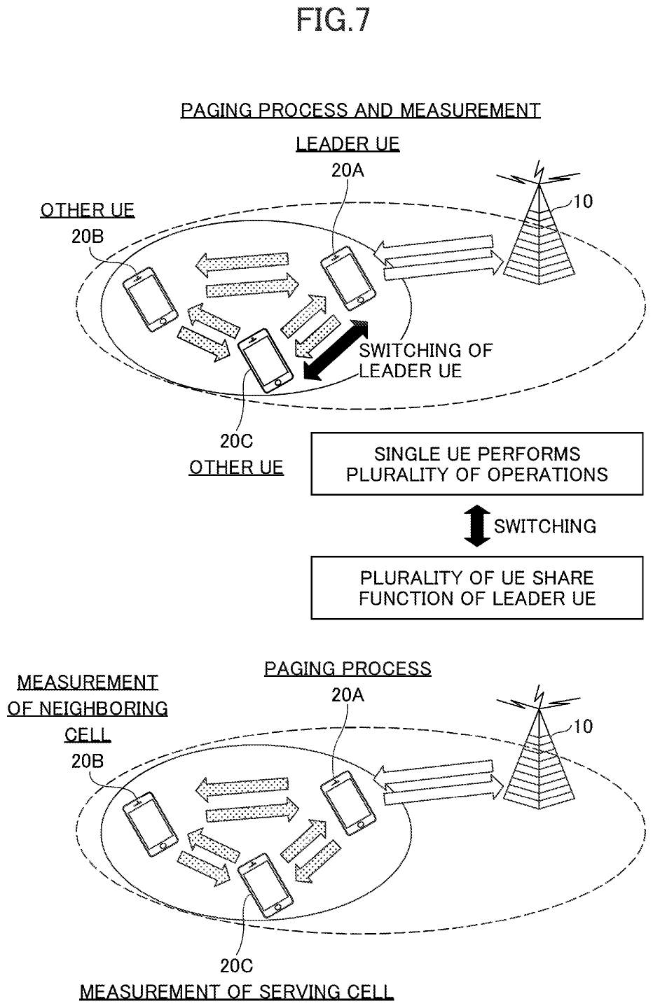

FIG. 7 is a diagram illustrating an operation example (1) of a leader UE according to the embodiment of the present invention. As shown in FIG. 7, the single leader UE may perform a plurality of operations. The leader UE may be switched to another UE in a group. Furthermore, as shown in FIG. 7, it may be possible to switch from a state in which the single leader UE performs a plurality of operations to a state in which a function of the leader UE is shared by a plurality of UEs. In the example of the state in which the function of the leader UE is shared by the plurality of UEs in FIG. 7, for example, the terminal 20A may perform a paging process, the terminal 20B may perform measurement of a neighboring cell, the terminal 20C may perform measurement of a serving cell, and the results may be shared by these terminals 20.

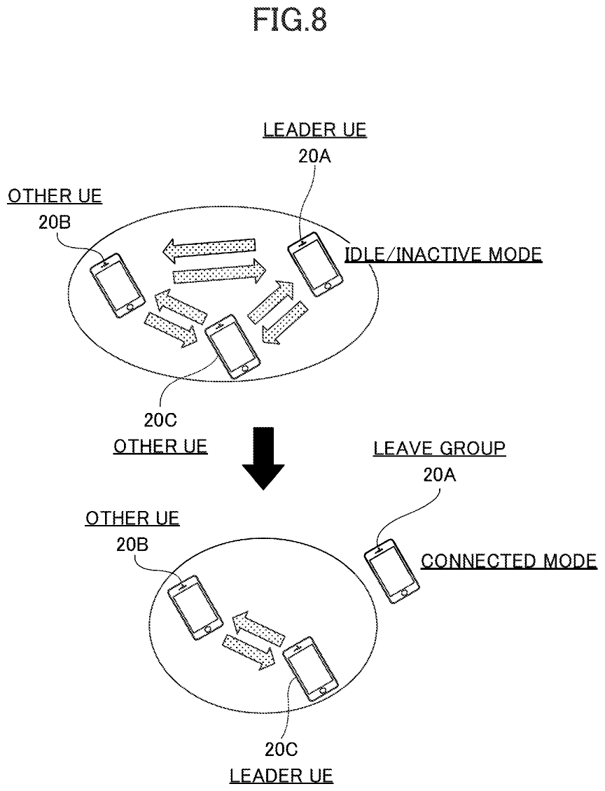

FIG. 8 is a diagram illustrating an operation example (2) of a leader UE according to the embodiment of the present invention. As shown in FIG. 8, when the state of the leader UE terminal 20A changes from an idle mode or inactive mode to a connected mode, the terminal 20A leaves a group and another UE terminal 20C may be determined as a leader UE. The determination of the leader UE as the terminal 20C may be notified to a base station 10 and the other UEs by the terminal 20C or the terminal 20A.

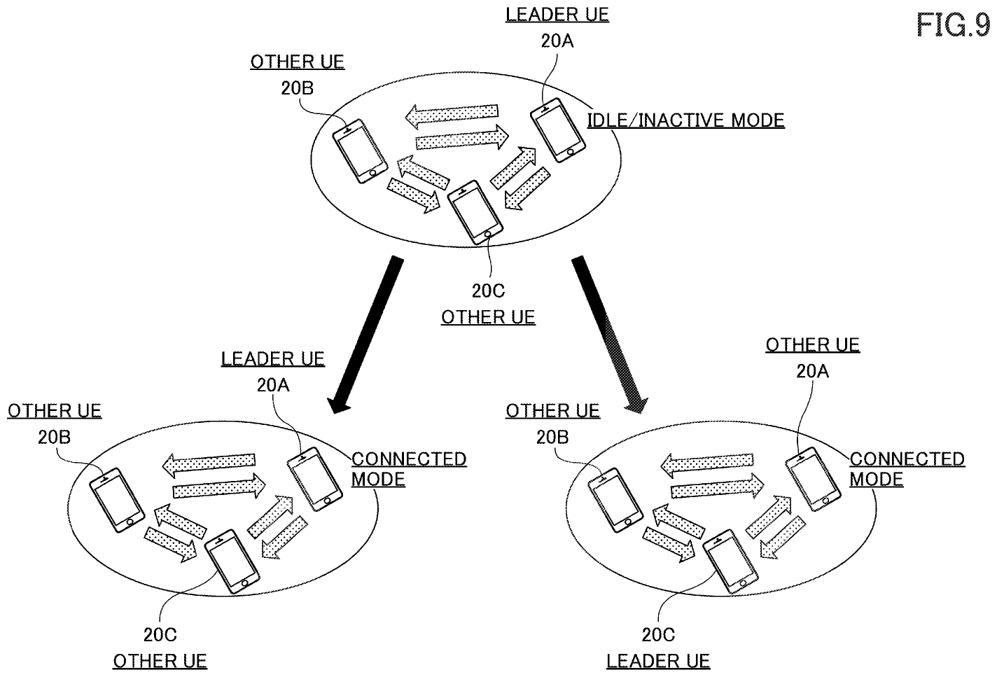

FIG. 9 is a diagram illustrating an operation example (3) of a leader UE according to the embodiment of the present invention. As shown in FIG. 8, when a state of the leader UE terminal 20A changes from an idle mode or inactive mode to a connected mode, the terminal 20A may remain in a group and remain as the leader UE. Alternatively, when a state of the leader UE terminal 20A changes from an idle mode or inactive mode to a connected mode, the terminal 20A remains in the group and comes to act as another UE, and another UE terminal 20C may come to act as a leader UE.

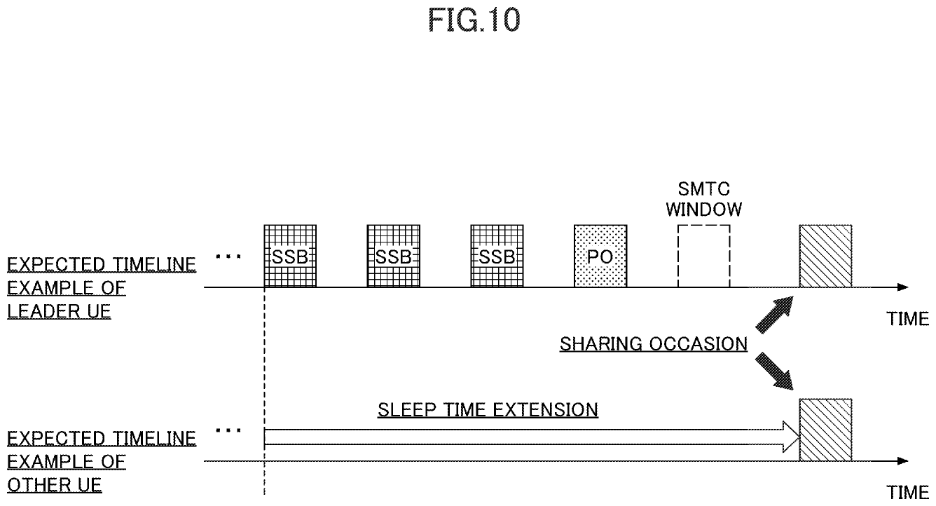

FIG. 10 is a diagram illustrating an example of a timeline of data sharing according to the embodiment of the present invention. As shown in FIG. 10, a leader UE may provide an occasion of notifying another UE of information or monitoring a response from the other UE. Hereinafter, the occasion is referred to as a “sharing occasion”. As shown in FIG. 10, since the other UE expects to perform an operation of receiving or transmitting at a sharing occasion, the UE can extend a sleep time. A radio resource used in a sharing occasion may be a downlink resource section, may be an uplink resource section, or may be a resource of another type (an X symbol, a Y slot, or the like).

A sharing occasion may be configured or changed to a leader UE in a manner stated in any of 1) to 4) shown below:
1) A sharing occasion may be preconfigured. A sharing occasion may be configured on a per group basis or a common sharing occasion may be configured for all groups as a common sharing occasion.
2) A sharing occasion may be notified from a base station 10 at a time of grouping or during grouping. For example, a sharing occasion may be notified using a network instruction through SIB, DCI, MAC-CE, or RRC signaling.
3) A sharing occasion may be notified when a state of a terminal 20 included in the group transitions. For example, a sharing occasion may be notified when a transition of the terminal 20 is made from an idle mode or an inactive mode to a connected mode.
4) A sharing occasion may be calculated from an identifier or the like assigned to a group or each terminal 20 such as an identifier dedicated to grouping or an identifier of a leader UE.

Whether or not a leader UE shares data with another UE at a sharing occasion may be determined as follows: For example, a leader UE may perform data sharing with another UE always at a sharing occasion; a leader UE may determine whether to share data with another UE at a sharing occasion based on SIB, DCI, MAC-CE, or RRC signaling from a base station; or a leader UE may determine whether to share data with another UE at a sharing occasion based on implementation of the leader UE.

A sharing occasion may be configured for a new dedicated signal or dedicated channel instead of an existing signal or channel. In each period, a plurality of sharing occasions may be configured instead of a single sharing occasion.

A terminal 20 belonging to a group may share group sharing information of any of the following 1) to 9) through a sharing occasion:
1) a group identifier
2) any of various RNTI (Radio Network Temporary Identifiers) (P-RNTI, RA-RNTI, etc.)
3) UE capability.
4) any of SI (System Information), ETWS, or TCI (Transmission Configuration Indicator)
5) configuration or availability of a reference signal (e.g., an existing reference signal such as a CSI-RS or a TRS, or a new reference signal)
6) a measurement result (of own cell, neighboring cell, a RSRP, a SINR, a RSSI, a RSRQ, or the like)
7) a UE identifier.
8) position information
9) configuration or availability of a sharing occasion

In addition, necessary information may be shared corresponding to a necessary terminal operation. All of the above information need not be shared.

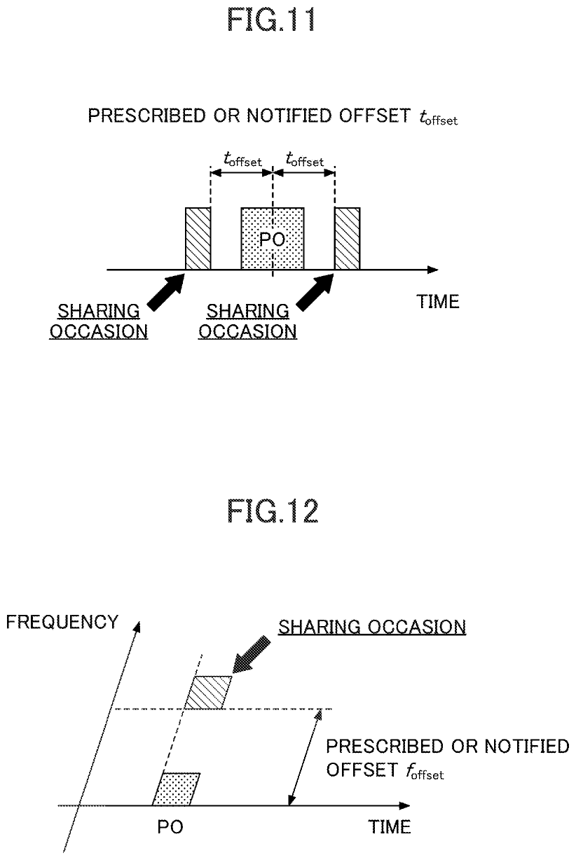

FIG. 11 is a diagram showing an example (1) of resources used for data sharing according to the embodiment of the present invention. As shown in FIG. 11, a sharing occasion may be configured in accordance with an offset t_{offset} in a time direction with respect to a PO. As shown in FIG. 11, a sharing occasion may be configured in accordance with a positive offset in the time direction, or may be configured in accordance with a negative offset in the time direction.

FIG. 12 is a diagram showing an example (2) of resources used for data sharing according to the embodiment of the present invention. As illustrated in FIG. 12, a sharing occasion may be configured in accordance with an offset f_{offset} in a frequency direction with respect to a PO. As shown in FIG. 12, a sharing occasion may be configured in accordance with a positive offset in the frequency direction. Also, a sharing occasion may be configured in accordance with a negative offset in the frequency direction.

In addition, a time position and a frequency position of a sharing occasion may be configured by designating an absolute position. A channel or signal used as a reference of an offset may be a channel or signal other than a PO, and may be, for example, a SSB.

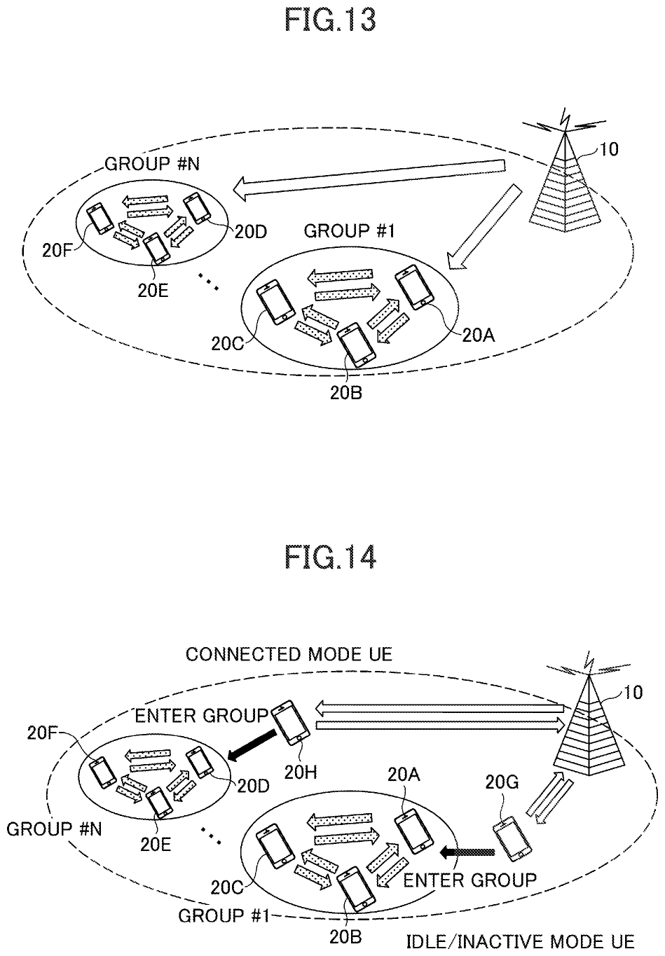

FIG. 13 is a diagram showing an example (1) of grouping according to the embodiment of the present invention. Terminals belonging to a group and the number of terminals may be determined in a manner as shown in any of 1) to 4) below. Although FIG. 13 illustrates an example of a group in which the number of terminals is three, the number of terminals may be any number equal to or greater than one.
1) A group may include only UEs each having transitioned to an idle mode or inactive mode.
2) A group may include a mixture of a UE or UEs each having transitioned to a connected mode and a UE or UEs each having transitioned to an idle mode or inactive mode.
3) The number of UEs per group and the total number of UE groups may be preconfigured.
4) The number of UEs per group and the total number of UE groups may be changed according to the number of UEs per cell.

For example, the number of terminals belonging to a group or the number of groups may be determined based on implementation of a leader UE, or may be determined based on SIB, DCI, MAC-CE, RRC signaling, or the like notified from a base station 10.

FIG. 14 is a diagram showing an example (2) of grouping according to the embodiment of the present invention. As illustrated in FIG. 14, a UE that is to enter a group may come to be included in the group in response to receiving an instruction from a base station 10. A UE that is to enter a group may be a terminal 20 that has been already included in a group or a terminal 20 that has not been included in a group. As shown in FIG. 14, a UE that is to enter a group may be a UE that is in an idle mode or inactive mode, or a UE that is in a connected mode.

For example, a group #1 may be a group including terminals 20 each in an idle mode or inactive mode. For example, a group #N may be a group including terminals 20 each in an idle mode or inactive mode and terminals 20 each in a connected mode. Information indicating an instruction to enter a group from the base station 10 may be notified through DCI, MAC-CE, RRC signaling, or the like.

A group may be formed at the initiative of a terminal 20 or a group may be formed at the initiative of a leader UE.

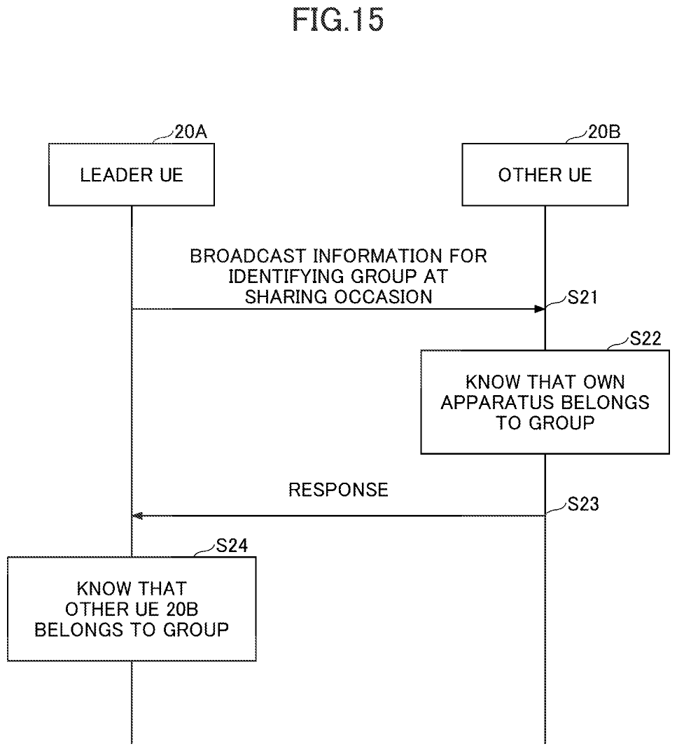

FIG. 15 is a sequence diagram illustrating an example (1) of group entering according to the embodiment of the present invention. In step S21, a leader UE 20A broadcasts information for identifying a group at a sharing occasion. The information for identifying a group may be, for example, a group identifier or an identifier of the leader UE. In the following step S22, another UE 20B knows that the UE 20B itself belongs to the group. When the other UE 20B receives information for identifying groups, the other UE may select a group based on implementation of the other UE or a specific parameter.

For example, when one or more signals including information for identifying groups are received, the other UE 20B may determine to select a group corresponding to a signal based on the power intensities or the qualities of the signals. For example, the other UE 20B may preferentially select a group corresponding to a signal whose quality is equal to or higher than X dB. The parameter X dB may be determined in advance, or may be notified from a base station 10, and may be changed. The parameter X dB may be notified from the base station 10 to the terminal 20 through SIB, DCI, MAC-CE, or RRC signaling.

In the following step S23, the other UE 20B sends a response to the leader UE. The information as the response may be designated by the base station 10 or may be determined in advance. For example, the information as the response may be a UE identifier, a C-RNTI, or the like. In the following step S24, the leader UE 20A knows that the other UE 20B belongs to the group.

The leader UE 20A may report information indicating the other UE 20B that belongs to the group known in step S23 to the base stations 10. The other UE 20B may be in an idle mode or an inactive mode or may be in a connected mode.

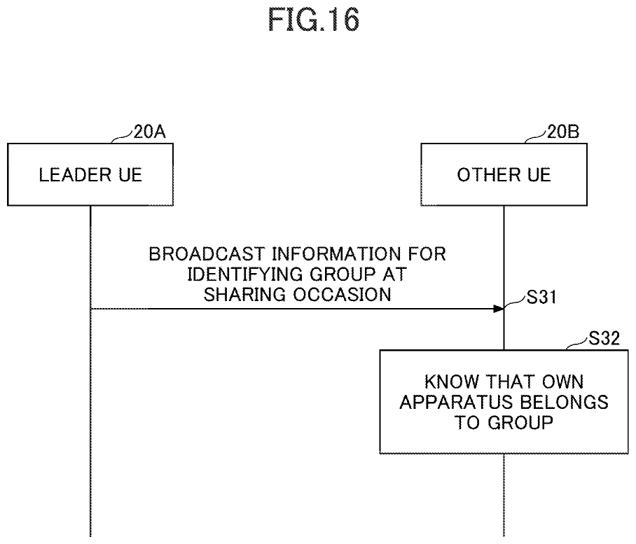

FIG. 16 is a sequence diagram illustrating an example (2) of group entering according to the embodiment of the present invention. In step S31, a leader UE 20A broadcasts information for identifying a group at a sharing occasion. The information for identifying the group may be, for example, a group identifier or an identifier of the leader UE. In the following step S32, another UE 20B knows that the other UE 20B itself belongs to the group. When the other UE 20B receives information for identifying groups, the other UE may select a group based on implementation of the other UE or a specific parameter. The leader UE 20A need not receive a response from the other UE 20B and need not know that the other UE 20B belongs to the group.

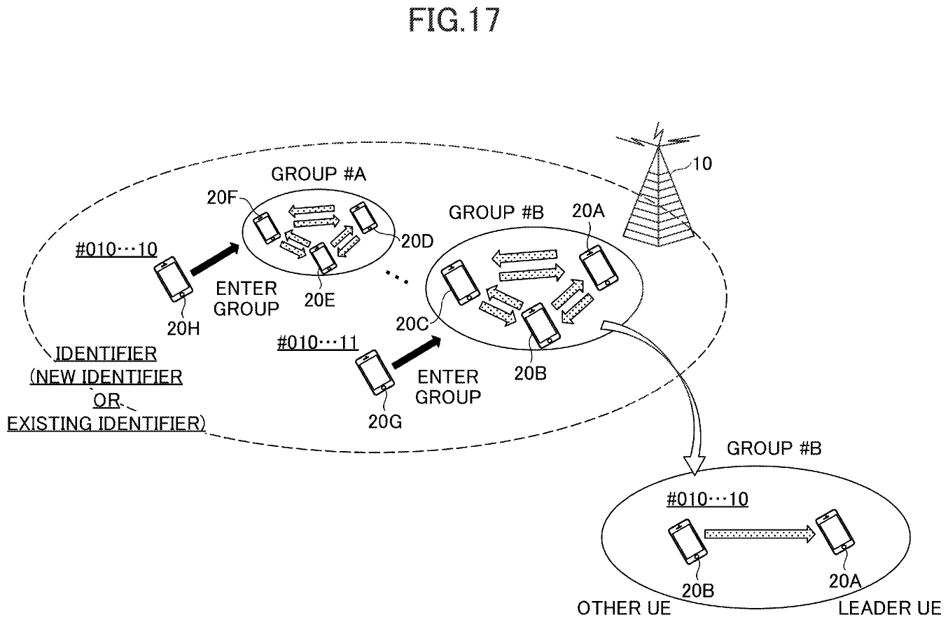

Grouping or group entering of a terminal 20 may be determined in advance. An identifier dedicated to grouping or group entering may be configured in a terminal 20 in advance, or group to enter may be determined by utilizing an existing identifier such as a UE identifier. The identifier dedicated to group entering may be determined in advance or may be notified from a base station 10. An identifier dedicated to grouping or group entering may be notified from a network through DCI, MAC-CE, or RRC signaling, or may be notified when a state of a terminal 20 transitions (for example, a state of a terminal 20 transitions from an idle mode or inactive mode to a connected mode, or transitions from a connected mode to an idle mode or inactive mode). When a state of a terminal 20 transitions, an identifier dedicated to grouping or group entering may be notified to the terminal 20 using a RRC release message or during a RACH process. FIG. 17 is a diagram showing an example (3) of grouping according to the embodiment of the present invention. As shown in FIG. 17, a terminal 20G may come to be included in a group #B in accordance with an assigned identifier #010 . . . 11, and a terminal 20H may come to be included in a group #A in accordance with an assigned identifier #010 . . . 10. In addition, another UE 20B in the group #B may notify or need not notify a leader UE 20A of an assigned identifier.

The group determination methods and the grouping (or group entering) methods of FIGS. 13 to 17 described above may be combined together.

Regarding a group switching method, when group switching is performed on another terminal 20 having been included in a group, a leader UE may be notified of the group switching of the other terminal 20 from a network. The other terminal 20 may be notified of the group switching of the other terminal 20 itself from the network or via the leader UE. The group switching of the other terminal 20 may be notified using DCI, MAC-CE, or RRC signaling from the network. In addition, as to a group switching method such as that described above, a group may be switched based on implementation of the other terminal 20.

In addition, as to a group switching method such as that described above, a criterion for group switching may be determined in advance. For example, when the signal strength and the signal quality (RSRP, SINR, RSSI, RSRQ, etc.) of a signal received at a sharing occasion in another group are better than those of a group to which the other terminal belongs, a timer may be started, and when the signal strength and the signal quality of a signal received at a sharing occasion in the other group are better continuously for a predetermined period of time, group switching may be executed. That is, the predetermined period may be set in the timer, and, in a case where the signal strength and the signal quality of a signal received at a sharing occasion in the other group are continuously good, the timer is maintained without being reset, and thus the timer expires as a result of the predetermined period elapsing, and then, the other terminal 20 may perform switching of the group.

Configuration and notification of a sharing occasion in another terminal 20 may be executed in a manner of any of 1) to 4) below.
1) A sharing occasion may be preconfigured. A sharing occasion may be configured on a per group basis or a common sharing occasion may be configured for all groups.
2) A sharing occasion may be notified when grouping (or group entering) is performed. For example, configuration of a sharing occasion may be notified using a network instruction (SIB, DCI, MAC-CE, RRC signaling).
3) A sharing occasion may be notified when the state of the terminal 20 transitions. For example, configuration of a sharing occasion may be notified using a RRC release message or during a RACH process.
4) Configuration of a sharing occasion may be calculated from an identifier assigned to a group or each terminal, such as an identifier dedicated to grouping or group entering, an ID of a leader UE, or an ID of the other UE.

In addition, availability of a sharing occasion in another terminal 20 may be notified in a manner of any of the following 1) to 3). “Availability of a sharing occasion” may be information indicating whether or not the sharing occasion can be used.
1) Availability of a sharing occasion in the other terminal 20 may be notified at a sharing occasion in an immediately preceding period.
2) Availability of a sharing occasion in the other terminal 20 may be notified using SIB, DCI, MAC-CE, or RRC signaling from a base station 10.
3) Availability of a sharing occasion in the other terminal 20 may be explicitly notified using a simple wireless system (which is different from that of communication between a base station 10 and a leader UE) such as RFID (Radio frequency identifier). For example, a simple signal such as a beacon may be transmitted from the leader UE to UEs in a group in order to notify of an occurrence or a nonoccurrence of data sharing.

Configuration or availability of a sharing occasion need not be notified to the other terminal 20. If configuration or availability of a sharing occasion is not notified, the terminal 20 may perform blind detection or need not monitor a sharing occasion.

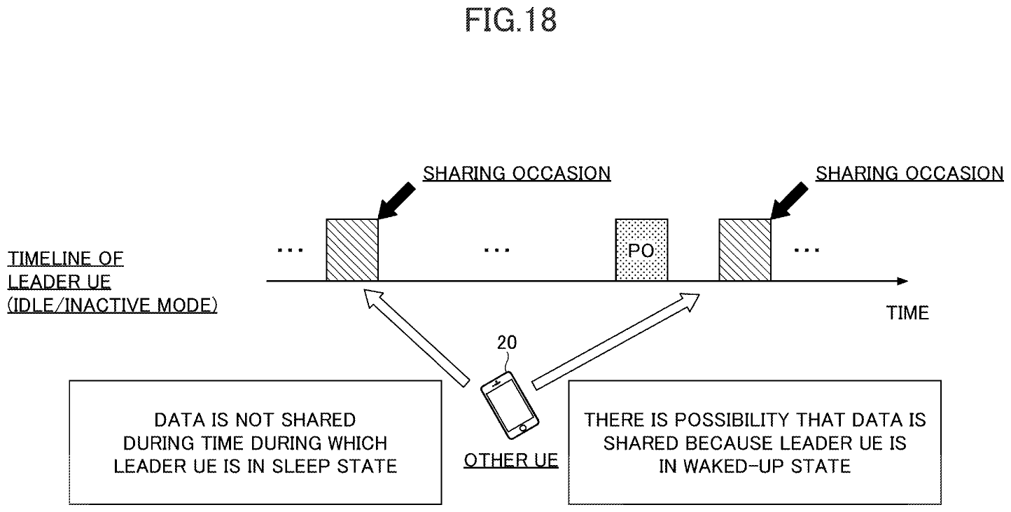

FIG. 18 is a diagram illustrating an operation example (1) of another UE according to the embodiment of the present invention. As an operation definition of another terminal 20, the other terminal 20 may determine operation based on the state (connected mode, idle mode, or inactive mode) of a leader UE. For example, when no availability notification is made at a sharing occasion, the other terminal 20 may determine operation based on the state of the leader UE.

As illustrated in FIG. 18, when the leader UE is in an idle mode or inactive mode, the other terminal 20 may monitor sharing occasions occurring before and after a PO of the leader UE on the assumption that data is shared from the leader UE there. In this regard, since the leader UE is in a sleep state when outside the PO, the other terminal 20 need not perform blind detection on a sharing occasion configured at a time other than before and after the PO of the leader UE on the assumption that data sharing is not performed there.

In a case where the leader UE is in a connected mode, the other terminal 20 may perform monitoring on the assumption that data is shared at a sharing occasion designated at a time and frequency position by the leader UE or a base station 10 regardless of positions of the PO and the sharing occasions of the leader UE.

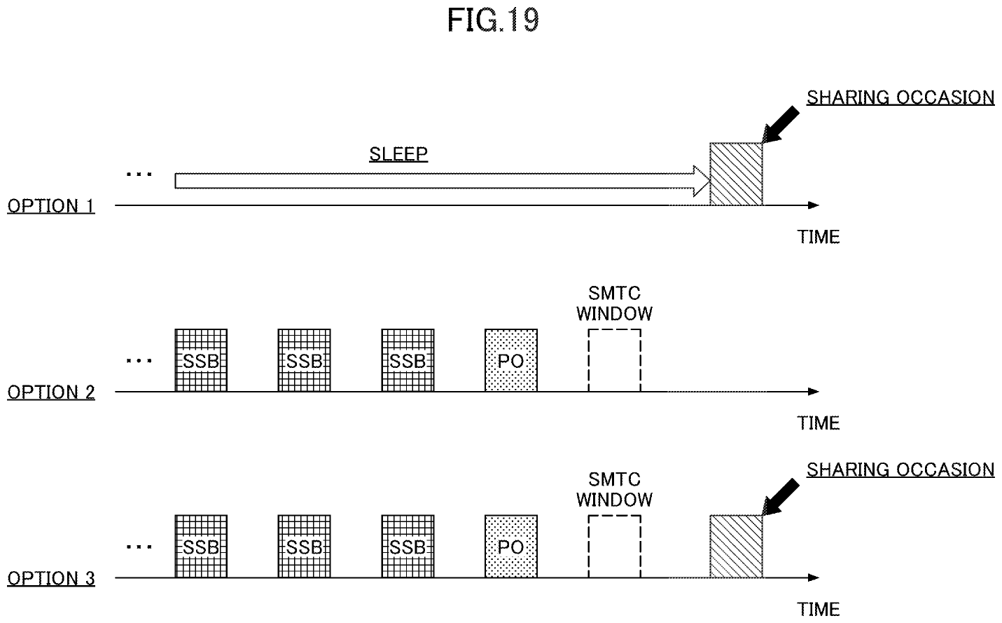

FIG. 19 is a diagram illustrating an operation example (2) of another UE according to the embodiment of the present invention. Another terminal 20 may perform any of operations of Option 1 to Option 3 illustrated in FIG. 19 based on UE implementation, or a leader UE or a base station 10 may designate which one of these operations the other terminal 20 is to perform. Note that the Options illustrated in FIG. 19 may be applied to another terminal 20 that is in an idle mode or inactive mode, or may be applied to another terminal 20 that is in a connected mode.

In Option 1, the other terminal 20 may be always in a sleep state except for a sharing occasion and may monitor a sharing occasion.

In Option 2, the other terminal 20 may perform a regular operation without monitoring a sharing occasion. That is, each terminal 20 may operate without receiving information from a leader UE.

In Option 3, the other terminal 20 may monitor a sharing occasion in addition to a regular operation.

For example, a UE capability as to whether or not a terminal 20 can form a group may be defined, and the terminal 20 may notify a network or a leader UE of the UE capability. In addition, for example, a UE capability as to whether or not a terminal 20 can act as a leader UE may be defined, and the terminal 20 may notify a network or a leader UE of the UE capability.

According to the above-described embodiment, a terminal 20 forms a group and shares information from a leader UE in the group, thereby efficiently executing a paging process, reception of system information, or obtaining a measurement result.

That is, it is possible to reduce power consumption of a terminal in an idle mode or inactive mode in a wireless communication system.

### Apparatus Configuration

Next, functional configuration examples of the base station 10 and the terminal 20 that execute the processes and operations described above will be described. The base station 10 and the terminal 20 include functions for implementing the above-described embodiment. However, each of the base station 10 and the terminal 20 may have only some of the functions of the embodiment.

### <Base Station 10>

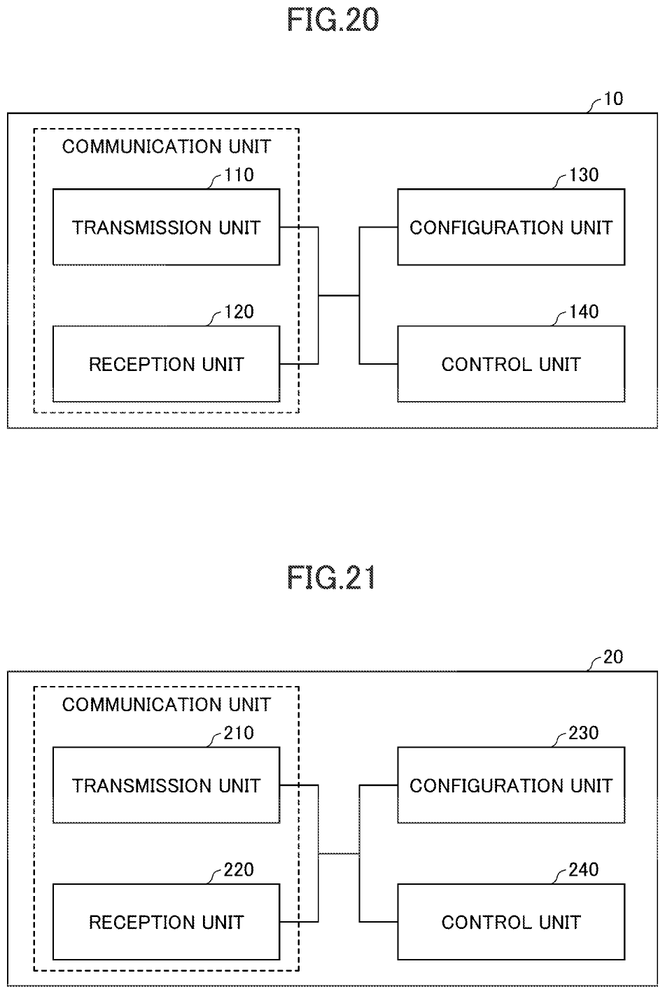

FIG. 20 is a diagram illustrating an example of a functional configuration of the base station 10 according to the embodiment of the present invention. As illustrated in FIG. 20, the base station 10 includes a transmission unit 110, a reception unit 120, a configuration unit 130, and a control unit 140. The functional configuration depicted in FIG. 20 is merely an example. As long as the operations according to the embodiment of the present invention can be executed, the function classifications and the names of the functional units may be freely determined.

The transmission unit 110 has a function of generating a signal to be transmitted to the terminal 20 side and wirelessly transmitting the signal. In addition, the transmission unit 110 transmits an inter-network-node message to another network node. The reception unit 120 has a function of receiving various signals transmitted from the terminal 20 and obtaining, for example, information of an upper layer from a received signal. Further, the transmission unit 110 has a function of transmitting an NR-PSS, an NR-SSS, an NR-PBCH, DL/UL control signals, and the like to the terminal 20. In addition, the reception unit 120 receives an inter-network-node message from another network node.

The configuration unit 130 stores configuration information configured in advance and various types of configuration information to be transmitted to the terminal 20. The contents of configuration information is, for example, information related to paging configuration.

As described above with regard to the embodiment, the control unit 140 performs control related to paging transmission. A functional unit related to signal transmission in the control unit 140 may be included in the transmission unit 110, and a functional unit related to signal reception in the control unit 140 may be included in the reception unit 120.

### <Terminal 20>

FIG. 21 is a diagram illustrating an example of a functional configuration of the terminal 20 according to the embodiment of the present invention. As illustrated in FIG. 21, the terminal 20 includes a transmission unit 210, a reception unit 220, a configuration unit 230, and a control unit 240. The functional configuration illustrated in FIG. 21 is merely an example. As long as the operations according to the embodiment of the present invention can be executed, the function classification and the names of the functional units may be freely determined.

The transmission unit 210 generates a transmission signal from transmission data and wirelessly transmits the transmission signal. The reception unit 220 wirelessly receives various signals and obtains a signal of an upper layer from a received signal of a physical layer. In addition, the reception unit 220 has a function of receiving NR-PSS, NR-SSS, NR-PBCH, DL/UL/SL control signals, or the like transmitted from the base station 10. In addition, for example, the transmission unit 210 transmits a physical sidelink control channel (PSCCH), a physical sidelink shared channel (PSSCH), a physical sidelink discovery channel (PSDCH), a physical sidelink broadcast channel (PSBCH), or the like to another terminal 20 as D2D communication, and the reception unit 220 receives PSCCH, PSSCH, PSDCH, PSBCH, or the like from another terminal 20.

The configuration unit 230 stores various types of configuration information received from the base station 10 by the reception unit 220. The configuration unit 230 also stores configuration information that is configured in advance. The contents of the configuration information are, for example, information related to paging configuration.

As described above with regard to the embodiment, the control unit 240 performs control related to paging reception. A functional unit related to signal transmission in the control unit 240 may be included in the transmission unit 210, and a functional unit related to signal reception in the control unit 240 may be included in the reception unit 220.

### Hardware Configuration

The block diagrams (FIGS. 20 and 21) used in the descriptions of the above-described embodiment depict the blocks on a per-function basis. Each of these functional blocks (components) is realized by any combination of at least one of hardware and software. A specific method of realizing the functional blocks is not particularly limited. That is, each functional block may be realized by using one physically or logically coupled device, or may be realized by directly or indirectly (for example, using a wire, wireless, or the like) coupling two or more physically or logically separated devices. Each functional block may be realized by combining software with one device or a plurality of devices.

The functions include, but are not limited to, determining, judging, calculating, computing, processing, deriving, investigating, searching, ascertaining, receiving, transmitting, outputting, accessing, resolving, selecting, choosing, establishing, comparing, assuming, expecting, deeming, broadcasting, notifying, communicating, forwarding, configuring, reconfiguring, allocating, mapping, assigning, and the like. For example, a functional block (component) configured to perform transmission is referred to as a transmission unit or a transmitter. In any case, as described above, the functional unit realizing method is not particularly limited.

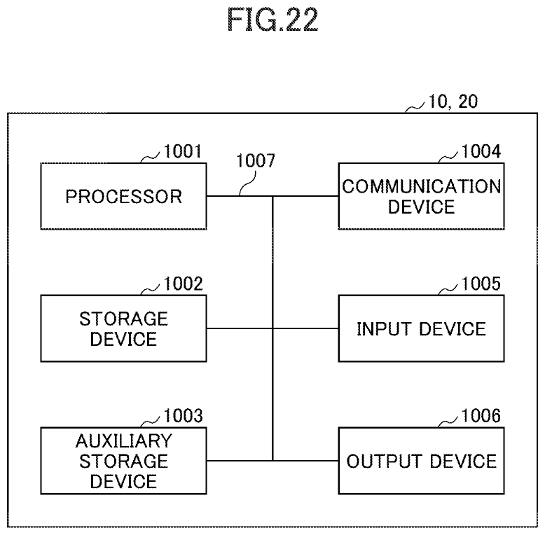

For example, each of the base station 10, the terminal 20, and the like according to the embodiment of the present disclosure may function as a computer that performs processing of the wireless communication method according to the present disclosure. FIG. 22 vis a diagram illustrating an example of a hardware configuration of the base station 10 and the terminal 20 according to the embodiment of the present disclosure. The base station 10 and the terminal 20 described above may be physically configured as a computer apparatus including a processor 1001, a storage device 1002, an auxiliary storage device 1003, a communication device 1004, an input device 1005, an output device 1006, a bus 1007, and the like.

In the following description, a term “apparatus” can be read as a circuit, a device, a unit, or the like. Hardware configurations of the base station 10 and the terminal 20 may be each configured to include one or more of the devices depicted in the drawing, or may be configured not to include some of the devices depicted in the drawing.

The functions in the base station 10 and the terminal 20 are realized by causing hardware such as the processor 1001 and the storage device 1002 to read predetermined software (program), causing the processor 1001 to perform arithmetic operations to control communication by the communication device 1004 or to control at least one of reading or writing of data in the storage device 1002 and the auxiliary storage device 1003.

The processor 1001 operates, for example, an operating system to control the entire computer. The processor 1001 may be configured by a central processing unit (CPU) including an interface with a peripheral device, a control device, an arithmetic device, a register, and the like. For example, each of the above-described control unit 140, control unit 240, and the like may be realized by the processor 1001.

The processor 1001 reads out a program (program code), a software module, data, or the like from at least one of the auxiliary storage device 1003 or the communication device 1004 to the storage device 1002, and executes various processes in accordance with the program, the software module, the data, or the like. As the program, a program that causes a computer to execute at least some of the operations described with regard to the above-described embodiment is used. For example, the control unit 140 of the base station 10 illustrated in FIG. 20 may be implemented by a control program stored in the storage device 1002 and executed by the processor 1001. In addition, for example, the control unit 240 of the terminal 20 illustrated in FIG. 21 may be implemented by a control program stored in the storage device 1002 and executed by the processor 1001. Although it has been described that the above-described various processes are executed by one processor 1001, the processes may be executed by two or more processors 1001 simultaneously or sequentially. The processor 1001 may be implemented by one or more chips. The program may be transmitted from a network via an electric communication line.

The storage device 1002 is a computer-readable recording medium, and may include at least one of a read-only memory (ROM), an erasable programmable ROM (EPROM), an electrically erasable programmable ROM (EEPROM), a random access memory (RAM), or the like. The storage device 1002 may be referred to as a register, a cache, a main memory (main storage device), or the like. The storage device 1002 can store programs (program codes), software modules, and the like that are executable to implement the communication methods according to the embodiment of the present disclosure.

The auxiliary storage device 1003 is a computer-readable recording medium, and may include at least one of an optical disk such as a compact disc ROM (CD-ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, or the like. The aforementioned storage medium may be, for example, a database including at least one of the storage device 1002 or the auxiliary storage device 1003, a server, or any other appropriate medium.

The communication device 1004 is hardware (transmission/reception device) for performing communication between computers via at least one of a wired network or a wireless network, and is also referred to as a network device, a network controller, a network card, a communication module, or the like, for example. The communication device 1004 may be configured to include a high-frequency switch, a duplexer, a filter, a frequency synthesizer, and/or the like in order to realize, for example, at least one of frequency division duplex (FDD) or time division duplex (TDD). For example, a transmitting/receiving antenna, an amplifying unit, a transmission/reception unit, a transmission path interface, and/or the like may be realized by the communication device 1004. The transmission/reception unit may be implemented in such a way that a transmission unit and a reception unit are physically or logically separated from each other.

The input device 1005 is an input device (for example, a keyboard, a mouse, a microphone, a switch, a button, a sensor, or the like) that receives input from the outside. The output device 1006 is an output device (for example, a display, a speaker, an LED lamp, or the like) that performs output to the outside. The input device 1005 and the output device 1006 may be integrated with each other (for example, as a touch panel).

These devices such as the processor 1001 and the storage device 1002 are connected by a bus 1007 for communicating information. The bus 1007 may be configured using a single bus, or may be configured using a different bus for each device.

Each of the base station 10 and the terminal 20 may be configured to include hardware such as a microprocessor, a digital signal processor (DSP), an application specific integrated circuit (ASIC), a programmable logic device (PLD), a field programmable gate array (FPGA), and/or the like; and some or all of the functional blocks may be realized by the hardware. For example, the processor 1001 may be implemented using at least one of these pieces of hardware.

### Summary of Embodiments

As described above, according to the embodiment of the present invention, there is provided a terminal including a communication unit configured to perform transmission of a signal to and reception of a signal from a base station; and a control unit configured to transmit, to another terminal, information that is received from the base station based on the transmission and the reception, or information that is obtained from the signal transmitted to or received from the base station.

According to the above configuration, a terminal 20 can form a group and share information from a leader UE in the group, thereby efficiently executing a paging process, reception of system information, or obtaining a measurement result. That is, it is possible to reduce power consumption of a terminal in an idle mode or inactive mode in a wireless communication system.

The signal may be a signal for the another terminal. With the above-described configuration, a terminal 20 can form a group and share information from a leader UE in the group, thereby efficiently executing a paging process and reception of system information.

The signal may be a paging message or a message related to an ETWS (Earthquake and Tsunami Warning System). According to the above-described configuration, a terminal 20 forms a group and shares information from a leader UE in the group, so that it is possible to efficiently execute a paging process or reception of system information.

The information obtained from the signal may be a measurement result. With the above-described configuration, a terminal 20 can form a group and share information from a leader UE in the group, thereby efficiently obtaining a measurement result.

The another terminal and the terminal may belong to a group, and the control unit may be configured to broadcast information for identifying the group for causing the another terminal to enter the group. According to the above configuration, a terminal 20 can form a group and share information from a leader UE in the group, thereby efficiently executing a paging process, reception of system information, or obtaining a measurement result.

Further, according to the embodiment of the present invention, there is provided a communication method in which a terminal performs a communication step of performing transmission of a signal to and reception of a signal from a base station; and a control step of transmitting, to another terminal, information that is received from the base station based on the transmission and the reception, or information that is obtained from the signal transmitted to or received from the base station.

According to the above configuration, a terminal 20 can form a group and share information from a leader UE in the group, thereby efficiently executing a paging process, reception of system information, or obtaining a measurement result. That is, it is possible to reduce power consumption of a terminal in an idle mode or inactive mode in a wireless communication system.

### Supplementary Explanation of Embodiment

Although the embodiment of the present invention have been described above, the disclosed invention is not limited to such an embodiment, and those skilled in the art will understand various variations, modifications, alterations, substitutions, and the like. Although the present invention has been described using specific numerical examples in order to facilitate understanding of the present invention, these numerical values are merely examples, and any appropriate values may be used unless otherwise specified. The separation of items in the above description is not essential to the present invention; and a point described in two or more items may be used in combination as necessary, and a point described in one item may be applied to a point described in another item (as long as there is no contradiction). The boundaries of functional units or processing units in the functional block diagrams do not necessarily correspond to the boundaries of physical components. The operations of a plurality of functional units may be physically performed by one component, or the operation of one functional unit may be physically performed by a plurality of components. With regard to processing procedures described in the embodiment, the order of processing may be changed as long as there is no contradiction. For convenience of description of processing, the base station 10 and the terminal 20 have been described using functional block diagrams, but such an apparatus may be implemented by hardware, software, or a combination thereof. Each of software executed by a processor included in the base station 10 according to the embodiment of the present invention and software executed by a processor included in the terminal 20 according to the embodiment of the present invention may be stored in any appropriate storage medium such as a random access memory (RAM), a flash memory, a read-only memory (ROM), an EPROM, an EEPROM, a register, a hard disk (HDD), a removable disk, a CD-ROM, a database, a server, or the like.

Notification of information is not limited to that in the embodiment described in the present disclosure, and may be performed using another method. For example, notification of information may be performed using physical layer signaling (for example, downlink control information (DCI) or uplink control information (UCI)), upper layer signaling (for example, radio resource control (RRC) signaling), MAC (Medium Access Control) signaling, broadcast information (MIB (Master Information Block), or SIB (System Information Block)), another signal, or a combination thereof. In addition, the RRC signaling may be referred to as an RRC message, and may be, for example, an RRC connection setup message, an RRC connection reconfiguration message, or the like.

The embodiment described in the present disclosure may be applied to at least one of systems using Long Term Evolution (LTE), LTE-Advanced (LTE-A), SUPER 3G, IMT-Advanced, 4G (4^{th} generation mobile communication system), 5G (5^{th} generation mobile communication system), Future Radio Access (FRA), New Radio (NR), W-CDMA (registered trademark), GSM (registered trademark), CDMA2000,

Ultra Mobile Broadband (UMB), IEEE 802.11 (Wi-Fi®), IEEE 802.16 (WiMAX®), IEEE 802.20, Ultra-WideBand (UWB), Bluetooth®, and other appropriate systems, and next-generation systems extended based thereon. In addition, the embodiment described in the present disclosure may be applied to a plurality of systems that are combined (for example, a combination of at least one of LTE or LTE-A with 5G).

The order of the processing procedures of sequences, flowcharts, and the like of each embodiment described in the present specification may be changed as long as there is no contradiction. For example, the methods described in the present disclosure use exemplified orders to present the elements of the various steps and are not limited to use the specific orders presented.

In the present specification, a specific operation described as being performed by the base station 10 may be performed by an upper node of the base station 10 in some cases. In a network including one or more network nodes including the base station 10, it is apparent that various operations performed for communication with the terminal 20 may be performed by at least one of the base station 10 or another network node (for example, but not limited to, an MME, an S-GW, or the like) other than the base station 10. Although the case where there is one network node other than the base station 10 has been exemplified above, this other network node may be a combination of a plurality of other network nodes (for example, an MME and an S-GW).

Information, a signal or the like described in the present disclosure may be output from an upper layer (or a lower layer) to a lower layer (or an upper layer). The signal or the like may be input or output via a plurality of network nodes.

The thus input/output information or the like may be stored in a specific location (for example, a memory) or may be managed using a management table. The input/output information or the like may be overwritten, updated, or appended. The output information or the like may be deleted. The input information or the like may be transmitted to another device.

Determination in the present disclosure may be implemented using a value (0 or 1) represented by one bit, may be performed using a Boolean value (true or false), or may be performed using comparison of numerical values (for example, comparison with a predetermined value).

Software should be interpreted broadly to mean an instruction, an instruction set, a code, a code segment, a program code, a program, a subprogram, a software module, an application, a software application, a software package, a routine, a subroutine, an object, an executable file, an executable thread, a procedure, a function, or the like, whether it is referred to as software, firmware, middleware, microcode, hardware description language, or another name.

Software, an instruction, information, or the like may be transmitted or received through a transmission medium. For example, if software is transmitted from a website, server, or another remote source using at least one of a wired technology (coaxial cable, optical fiber cable, twisted pair, digital subscriber line (DSL), etc.) or a wireless technology (infrared, microwave, etc.), the at least one of the wired technology or wireless technology is included in the definition of the transmission medium.

The information, signals, and the like described in the present disclosure may be expressed using any of a variety of different technologies. For example, data, an instruction, a command, information, a signal, a bit, a symbol, a chip, and the like that may be cited throughout the above description may be expressed by a voltage, a current, an electromagnetic wave, a magnetic field or a magnetic particle, an optical field or a photon, or any combination thereof.

It should be noted that the terms described in the present disclosure and the terms necessary for understanding the present disclosure may be replaced with terms having the same or similar meanings. For example, at least one of a channel or a symbol may be a signal (signaling). The signal may be a message. A component carrier (CC) may be referred to as a carrier frequency, a cell, a frequency carrier, or the like.

The terms “system” and “network” used in the present disclosure are used interchangeably.

In addition, the information, the parameters, and the like described in the present disclosure may be represented by using absolute values, may be represented by using relative values with respect to predetermined values, or may be represented by using other corresponding information. For example, a radio resource may be represented by an index.

The names used for the above-mentioned parameters are in no way restrictive. Furthermore, equations and the like that use these parameters may differ from those explicitly disclosed in the present disclosure. The various channels (e.g., PUCCH, PDCCH, etc.) and information elements may be identified by any suitable names, and thus the various names assigned to these various channels and information elements are in no way restrictive.

In the present disclosure, terms such as “base station (BS)”, “radio base station”, “base station apparatus”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier” and the like may be used interchangeably. The base station may also be referred to by a term such as a macro cell, a small cell, a femto cell, a pico cell, etc.

The base station can cover one or more (e.g., three) cells. When the base station covers multiple cells, the entire coverage area of the base station may be divided into multiple smaller areas, and each smaller area may also provide a communication service by a base station subsystem (for example, an indoor small base station (remote radio head (RRH)). The term “cell” or “sector” refers to part or all of the coverage area of at least one of the base station or the base station subsystem that provides the communication service in this coverage.

In the present disclosure, the terms “mobile station (MS), ” “user terminal, ” “user equipment (UE), ” “terminal, ” and the like may be used interchangeably.

A mobile station may also be referred to, by those skilled in the art, by a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or any one of some other suitable terms.

At least one of the base station or the mobile station may be referred to by a transmission device, a reception device, a communication device, or the like. Note that at least one of the base station or the mobile station may be a device mounted on a mobile body, may be a mobile body itself, or the like. The mobile body may be a vehicle (for example, a car, an airplane, or the like), a mobile body that moves without an operator (for example, a drone, an automatic driving vehicle, or the like), or a robot (manned or unmanned). At least one of the base station or the mobile station may be a device that does not necessarily move during a communication operation. For example, at least one of the base station or the mobile station may be an Internet of Things (IOT) device such as a sensor.

Also, the base station in the present disclosure may be read as a user terminal. For example, each embodiment of the present disclosure may be applied to a configuration in which communication between the base station and the user terminal is replaced with communication between a plurality of terminals 20 (which may be referred to as D2D (Device-to-Device), V2X (Vehicle-to-Everything), or the like, for example). In this case, the terminal 20 may have the functions of the base station 10 described above. In addition, terms such as “up” and “down” may be replaced with terms (for example, “side”) corresponding to terminal-to-terminal communication. For example, an uplink channel, a downlink channel, and the like may be read as side channels.

Similarly, the user terminal in the present disclosure may be read as a base station. In this case, the base station may be configured to have the functions of the above-described user terminal.

The term “determining” used in the present disclosure may mean any one of a wide variety of actions. “Determining” may mean considering that, for example, it has been “determined” to have perform judging, calculating, computing, processing, deriving, investigating, looking up, searching, or inquiring (e.g., searching a table, a database, or another data structure), ascertaining, or the like. Also, “determining” may mean considering that it has been “determined” to have perform, for example, receiving (e.g., receiving information), transmitting (e.g., transmitting information), inputting, outputting, accessing (e.g., accessing data in a memory), or the like. In addition, “determining” may mean considering that it has been determined to have perform resolving, selecting, choosing, establishing, comparing, or the like. That is, “determining” may mean considering that it has been “determined” to have perform a certain operation. In addition, “determining” may be replaced with “assuming”, “expecting”, “considering”, or the like.

The term “connected, ” “coupled, ” or any variation thereof, refers to any connection or coupling, either direct or indirect, between two or more elements, and may mean presence of one or more intermediate elements between two elements that are “connected” or “coupled” to each other. The coupling or connection between the elements may be physical, logical, or a combination thereof. For example, “connection” may be read as “access”. As used in the present disclosure, the two elements may be considered as being “connected” or “coupled” to each other using one or more wires, cables, or printed electrical connections, or any combinations thereof, as well as using any one of some non-restrictive and non-inclusive examples, such as electromagnetic energy having a wavelength in a radio frequency range, a microwave range, or an optical (visible or invisible) range.

The reference signal may be abbreviated to RS (reference signal), and may be referred to as a pilot depending on an applied standard.

As used in the present disclosure, words “based on” do not mean “based only on” unless expressly specified otherwise. In other words, the words “based on” have both of a meaning of “based only on” and a meaning of “based at least on”.

Any reference to elements using designations such as “first, ” “second, ” and the like as used in the present disclosure does not generally limit the quantities or order of these elements. These designations may be used in the present disclosure as a convenient method of distinguishing between two or more elements. Thus, a reference to first and second elements does not mean that only two elements may be used and does not mean that the first element must precede the second element in some manner.

“Means” as any element of each apparatus described above may be replaced with “unit”, “circuit”, “device”, or the like.

Where “include”, “including” or any variation thereof is used in the present disclosure, these terms are intended to be inclusive in a manner similar to the term “comprising.” Furthermore, the term “or” as used in the present disclosure is intended not to be “exclusive or”.

A radio frame may include one or more frames with respect to a time domain. With respect to the time domain, any one of the one or more frames may be referred to as a subframe. The subframe may include one or more slots with respect to the time domain. The subframe may have a fixed length of time (e.g., 1 ms) that is not dependent on numerology.

The numerology may be a communication parameter applied to at least one of transmission or reception of a certain signal or channel. The numerology may represent, for example, at least one of a subcarrier spacing (SCS), a bandwidth, a symbol length, a cyclic prefix length, a transmission time interval (TTI), the number of symbols per TTI, a radio frame configuration, a specific filtering process performed by a transmitter-receiver with respect to a frequency domain, a specific windowing process performed by a transmitter-receiver with respect to a time domain, or the like.

A slot may include one or more symbols (OFDM (Orthogonal Frequency Division Multiplexing) symbols, SC-FDMA (Single Carrier Frequency Division Multiple Access) symbols, or the like). A slot may be a time unit based on numerology.

Ae slot may include a plurality of mini-slots. Each minislot may include one or more symbols with respect to a time domain. A minislot may also be referred to as a subslot. A minislot may include a smaller number of symbols than those of a slot. A PDSCH (or PUSCH) transmitted in a time unit greater than a minislot may be referred to as a PDSCH (or PUSCH) mapping type A. A PDSCH (or PUSCH) transmitted using a minislot may be referred to as a PDSCH (or PUSCH) mapping type B.

Each of a radio frame, a subframe, a slot, a minislot, and a symbol represents a time unit for transmitting a signal. A radio frame, a subframe, a slot, a minislot, and a symbol may be referred to by respective different names.

For example, one subframe may be referred to as a transmission time interval (TTI); a plurality of contiguous subframes may be referred to as a TTI; or one slot or one minislot may be referred to as a TTI. That is, at least one of a subframe or a TTI may be a subframe (1 ms) in the existing LTE, may have a length shorter than 1 ms (for example, 1 to 13 symbols), or may have a length longer than 1 ms. Note that units expressing a TTI may be referred to as slots, minislots, or the like instead of subframes.

A TTI refers to, for example, a shortest time unit of scheduling in wireless communication. For example, in a LTE system, the base station performs scheduling for allocating radio resources (a frequency bandwidth, transmission power, and the like that can be used in each terminal 20) to each terminal 20 on a per TTI basis. Note that the definition of TTI is not limited to this.

TTIs may be used as transmission time units of transmitting a channel-coded data packet (transport block), a code block, a code word, or the like, or may be used as processing units for scheduling, link adaptation, or the like. When a TTI is given, a time interval (for example, the number of symbols) to which a transport block, a code block, a code word, or the like is actually mapped may be shorter than the TTI.

When one slot or one minislot is referred to as a TTI, one or more TTIs (i.e., one or more slots or one or more minislots) may be used as the shortest time unit of scheduling. In addition, the number of slots (the number of minislots) used as the shortest time unit of scheduling may be controlled.

A TTI having a time length of 1 ms may be referred to as a regular TTI (a TTI according to LTE Rel. 8-12), a normal TTI, a long TTI, a regular subframe, a normal subframe, a long subframe, a slot, or the like. A TTI that is shorter than a regular TTI may be referred to as a shortened TTI, a short TTI, a partial or fractional TTI, a shortened subframe, a short subframe, a minislot, a subslot, a slot, or the like.

Note that a long TTI (for example, a regular TTI, a subframe, or the like) may be replaced with a TTI having a time length exceeding 1 ms, and a short TTI (for example, a shortened TTI or the like) may be replaced with a TTI having a TTI length less than the TTI length of a long TTI and equal to or greater than 1 ms.

A resource block (RB) is a resource allocation unit with respect to a time domain and a frequency domain, and may include one or more contiguous subcarriers with respect to the frequency domain. The number of subcarriers included in a RB may be the same regardless of the numerology, for example, 12. The number of subcarriers included in a RB may be determined based on the numerology.

In addition, the time domain of a RB may include one or more symbols, and may have a length of 1 slot, 1 mini-slot, 1 subframe, or 1 TTI. 1 TTI, 1 subframe or the like may include one or more resource blocks.

Note that the one or more RBs may be referred to as a physical resource block (PRB or Physical RB), a subcarrier group (SCG), a resource element group (REG), a PRB pair, a RB pair, or the like.

A resource block may include one or more resource elements (REs). For example, a 1 RE may have a radio resource area of one subcarrier and one symbol.

A bandwidth part (BWP) (which may also be referred to as a partial bandwidth, etc.) may refer to a subset of contiguous common resource blocks

(RBs) for a certain numerology with respect to a certain carrier. The common RBs may be identified by indexes of the RBs with respect to a common reference point of the carrier. PRBs may be defined with respect to a certain BWP and may be numbered in the BWP.

A BWP may be a BWP for UL (UL BWP) and may be a BWP for DL (DL BWP). For a UE, one or more BWPs may be configured in one carrier.

At least one of the configured BWPs may be active and a UE need not be expected to transmit or receive a certain signal/channel outside the active BWP. Each of “cell”, “carrier”, and the like in the present disclosure may be replaced with “BWP”.

The above-described structures of a radio frame, a subframe, a slot, a minislot, and a symbol are merely examples. For example, configurations such as the number of subframes included in a radio frame, the number of slots per subframe or radio frame, the number of minislots included in a slot, the number of symbols and RBs included in a slot or minislot, the number of subcarriers included in an RB, the number of symbols in a TTI, a symbol length, a cyclic prefix (CP) length, and the like can be changed variously.

In the present disclosure, for example, when articles are added by translation, such as a, an, and the in English, the present disclosure should be interpreted as nouns following these articles may be plurals.

In the present disclosure, the term “A and B are different” may mean “A and B are different from each other”. It should be noted that the term may also mean that “A and B are each different from C”. The same way of interpretation as this way for the term “different” should be applied to each of terms such as “separated”, “coupled” and the like.

Each embodiment described in the present disclosure may be used alone, may be used in combination, or may be switched with another appropriately when being actually implemented. In addition, notification of predetermined information (for example, notification of “it being X”) is not limited to being performed explicitly, and may be performed implicitly (for example, by avoiding notification of the predetermined information). Although the present disclosure has been described in detail above, it is apparent to those skilled in the art that the present disclosure is not limited to the embodiment described in the present disclosure. The present disclosure can be implemented as modified and changed embodiments without departing from the intent and scope of the present disclosure defined by the description of the claims. Accordingly, the description of the present disclosure is for an illustrative purpose, and in no way has a restrictive purpose with respect to the present disclosure.

### DESCRIPTION OF SYMBOLS

10 base station
110 transmission unit
120 reception unit
130 configuration unit
140 control unit
20 terminal
210 transmission unit
220 reception unit
230 configuration unit
240 control unit
1001 processor
1002 storage device
1003 auxiliary storage device
1004 communication device
1005 input device
1006 output device

1. A terminal comprising:
a communication unit configured to perform transmission of a signal to and reception of a signal from a base station; and
a control unit configured to transmit, to another terminal, information that is received from the base station based on the transmission and the reception, or information that is obtained from the signal transmitted to or received from the base station.

2. The terminal as claimed in claim 1,
wherein
the signal is a signal for the another terminal.

3. The terminal as claimed in claim 2,
wherein
the signal is a paging message or a message related to an ETWS (Earthquake and Tsunami Warning System).

4. The terminal as claimed in claim 1,
wherein
the information obtained from the signal is a measurement result.

5. The terminal as claimed in claim 1,
wherein
the another terminal and the terminal belong to a group, and
the control unit is configured to broadcast information for identifying the group for causing the another terminal to enter the group.

6. A communication method executed by a terminal, the communication method comprising:
a communication step of performing transmission of a signal to and reception of a signal from a base station; and
a control step of transmitting, to another terminal, information that is received from the base station based on the transmission and the reception, or information that is obtained from the signal transmitted to or received from the base station.
